(19) United States
(12) Patent Application Publication
(10) Pub. No.: US 2008/0133773 A1
(43) Pub. Date: Jun. 5, 2008

(54) Reporting System, Mobile Terminal Device, and Server Device

(75) Inventors: Tomoharu Kaneko, Kanagawa (JP); Yoshikazu Ishii, Osaka (JP); Tsutomu Kito, Kanagawa (JP); Tomohiro Iwama, Kanagawa (JP); Yuko Takei, Tokyo (JP); Masato Tanaka, Kanagawa (JP); Yasuhiro Aoyoma, Tokyo (JP); Tsutomu Iwai, Kanagawa (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 11/630,381

(22) PCT Filed: Jun. 17, 2005
(86) PCT No.: PCT/JP05/11152

§ 371 Date: Aug. 29, 2007

(30) Foreign Application Priority Data
Jun. 29, 2004 (JP) 2004-191765
Jun. 8, 2005 (JP) 2005-167695

(51) Int. Cl. G06F 15/16

(52) U.S. Cl. 709/245

(57) ABSTRACT

There are provided a report system, a mobile terminal device, and a server device capable of improving the reliability of report to a user. In the report system, an address management server device (105) acquires the latest address information on a mobile terminal device (101). A home server device (109) stores (holds) content information from an electric device (110) and performs control to acquire address information on the mobile terminal device from the address management server device (105). The home server device (109) transmits the stored content information from the address management server device (105) to the mobile terminal device (101) specified by the address information acquired from the address management server device (105). The mobile terminal device (101) receives the content information transmitted from the home server device (109) and reports the content of the content information.

### TECHNICAL FIELD

The present invention relates to a reporting system, mobile terminal apparatus and server apparatus, and more particularly, to a reporting system for information that is necessary to be reported from an electrical apparatus to a user, and a mobile terminal apparatus and server apparatus constituting the system.

### BACKGROUND ART

Conventional reporting systems that remotely control for example, an indoor electrical apparatus via a network, and report a change of state of the electrical apparatus to a user having a mobile terminal apparatus (see patent documents 1 to 3)

With these conventional reporting systems, a transmission destination (such as a telephone number and mail address) of a user to whom a change of state of the electrical apparatus is reported, is beforehand registered, and when an event necessary to be reported to the user occurs, a report request is transmitted to an event reporting apparatus, and the event reporting apparatus reports the event to the mobile terminal apparatus owned by the user of the beforehand registered transmission destination.
Patent Document 1: Japanese Laid-Open Patent Application No. 2001-326980
Patent Document 2: Japanese Laid-Open Patent Application No. 2002-186065
Patent Document 3: Japanese Laid-Open Patent Application No. 2003-319572

### DISCLOSURE OF INVENTION

### Problems to be Solved by the Invention

However, with the conventional reporting systems, when the mobile terminal apparatus cannot communicate at a timing when the event to be reported the user occurs, the report request disappears, and the report to the user is not carried out after that, and a problem arises that reporting to the user lacks reliability.

Further, with widespread use of wireless LAN such as IEEE802.11, a case is considered where the mobile terminal apparatus is a terminal apparatus connectable to the Internet. In this case, the transmission destination of event report is specified by IP address. The IP address of the mobile terminal apparatus changes according to a place where the mobile terminal apparatus exists, the event reporting apparatus cannot register the transmission destination beforehand, and also in this respect, there is a problem that reporting to the user lacks reliability.

It is therefore an object of the present invention to provide a reporting system, mobile terminal apparatus and server apparatus for improving reliability of reporting to the user.

### Means for Solving the Problem

A reporting system of the present invention adopts a configuration having a mobile terminal apparatus, a first server apparatus that controls transmission of transfer information to be informed to the mobile terminal apparatus, and a second server apparatus that manages address information of the mobile terminal apparatus, where the first server apparatus has a holding section that holds the transfer information, an address information acquiring section that acquires the address information from the second server apparatus, and a transmission controlling section that controls transmission of the transfer information to the second server apparatus when the address information acquiring section is not able to acquire the address information, the second server apparatus has a holding section that holds the transfer information from the first server apparatus, an address information acquiring section that acquires the address information from the mobile terminal apparatus, and a transmitting section that transmits the transfer information held in the holding section to the mobile terminal apparatus specified by the address information, and the mobile terminal apparatus has a receiver that receives the transfer information, and a reporting section that reports the received transfer information.

### ADVANTAGEOUS EFFECT OF THE INVENTION

According to the present invention, the server apparatus stores content information, acquires the latest address information of the mobile terminal apparatus, and transmits the content information to this latest address information, so that it is possible to provide the reporting system, mobile terminal apparatus and server apparatus for improving the reliability of reporting to the user in the mobile terminal apparatus.

### BRIEF DESCRIPTION OF DRAWINGS

FIG. 1 is an entire configuration diagram of a reporting system according to an embodiment of the present invention;

FIG. 2 is a diagram illustrating address registration processing of a mobile terminal apparatus of FIG. 1;

FIG. 3 is a diagram explaining a flow of the operations of the reporting system of FIG. 1;

FIG. 4 is a diagram explaining a configuration of an address acquisition control message;

FIG. 5 is a diagram explaining a configuration of an address search message;

FIG. 6 is a diagram explaining a configuration of a successful search result message;

FIG. 7 is a diagram explaining a configuration of a failed search result message;

FIG. 8 is a diagram explaining a configuration of an acquisition address message;

FIG. 9 is another diagram explaining the flow of the operations of the reporting system of FIG. 1;

FIG. 10 is a diagram explaining a configuration of a failure address acquisition message;

FIG. 11 is a diagram explaining a configuration of an event/content message;

FIG. 12 is a diagram explaining a configuration of a registration address message;

FIG. 13 is a block diagram illustrating a configuration of the mobile terminal apparatus of FIG. 1;

FIG. 14 is a block diagram illustrating a configuration of an address managing server apparatus of FIG. 1;

FIG. 15 is a diagram showing an example of a table in a storage section of FIG. 14;

FIG. 16 is a block diagram illustrating a configuration of an application server apparatus of FIG. 1;

FIG. 17 is a diagram showing an example of a table in a storage section of the application server apparatus of FIG. 16;

FIG. 18 is a block diagram illustrating a configuration of a home server apparatus of FIG. 1;

FIG. 19 is a diagram showing an example of a table in a storage section of the home server apparatus of FIG. 18;

FIG. 20 is another diagram explaining the flow of operations in the reporting system of FIG. 1;

FIG. 21 is another diagram explaining the flow of operations in the reporting system of FIG. 1; and

FIG. 22 is still another diagram explaining the flow of operations in the reporting system of FIG. 1.

### BEST MODE FOR CARRYING OUT THE INVENTION

An embodiment of the present invention will be described in detail below with reference to accompanying drawings.

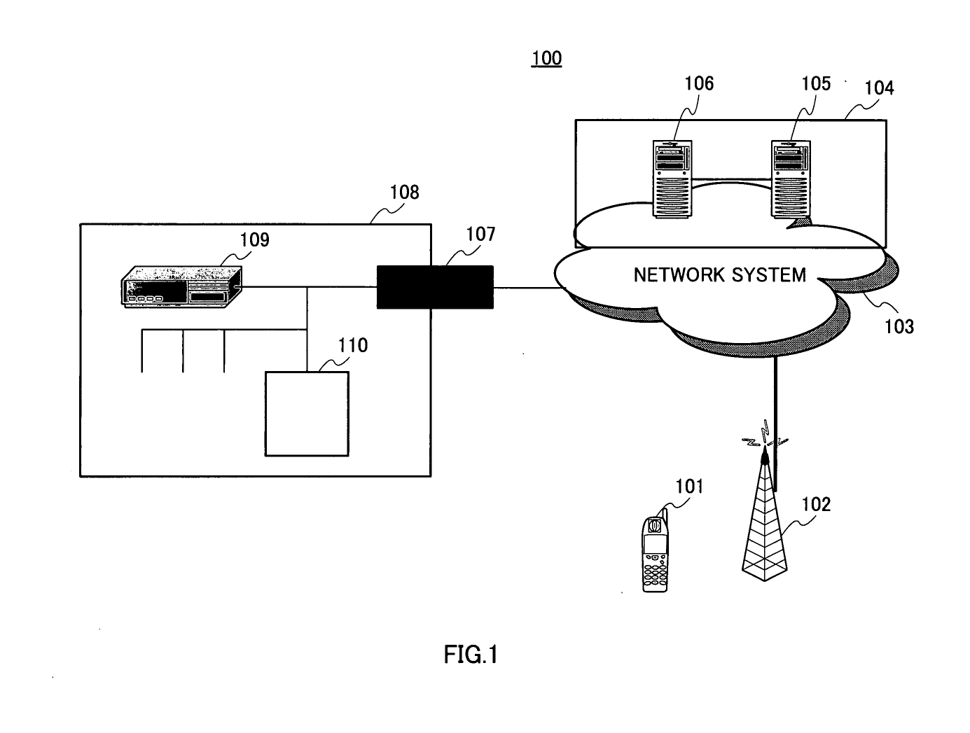

First, the entire configuration of a reporting system according to this embodiment will be described with reference to FIG. 1.

FIG. 1 is the entire configuration diagram of reporting system 100.

As shown in FIG. 1, reporting system 100 has: mobile terminal apparatus 101; base station apparatus 102; network system 103; ASP network system 104; address managing server apparatus 105; application server apparatus 106; router apparatus 107; home network system 108; home server apparatus 109; and household electrical apparatus 110.

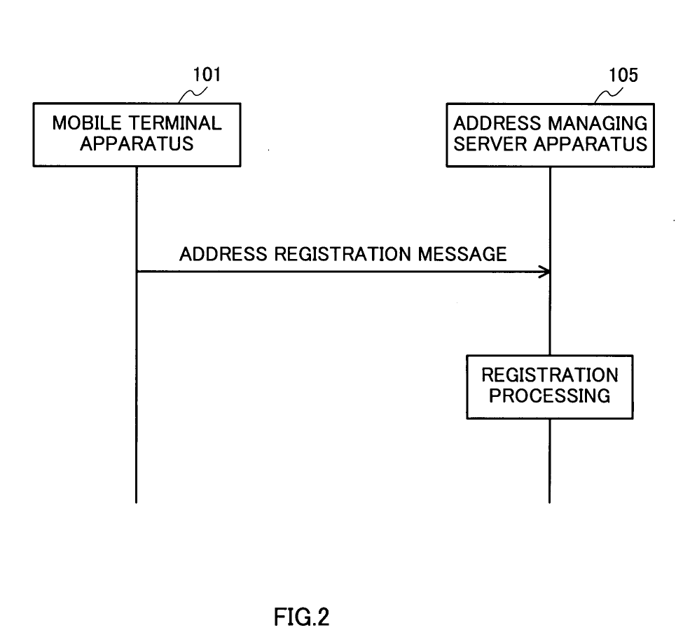

FIG. 2 is a diagram illustrating address registration processing in mobile terminal apparatus 101.

As shown in FIG. 2, mobile terminal apparatus 101 performs “address registration processing,” for example, when mobile terminal apparatus 101 is powered on, or enters a communication zone with the network system, or when the address information is changed. Specifically, when connected to network system 103, mobile terminal apparatus 101 transmits an address registration message to address managing server apparatus 105. More specifically, when connected to network system 103, mobile terminal apparatus 101 transmits address information (for example, IP address) assigned at network system 103, together with mobile terminal identification information for identifying mobile terminal apparatus 101 and a user ID for identifying a user of mobile terminal apparatus 101 to address managing server apparatus 105 of ASP network system 104 via base station apparatus 102 and network system 103. Mobile terminal apparatus 101 may be configured to perform “address registration processing” at predetermined intervals.

Address managing server apparatus 105 associates the address information from mobile terminal apparatus 101 with the mobile terminal identification information for identifying mobile terminal apparatus 101 and the user ID, and store the result. By this means, even when the address information of mobile terminal apparatus 101 changes, address managing server apparatus 105 is able to manage new address information of mobile terminal apparatus 101.

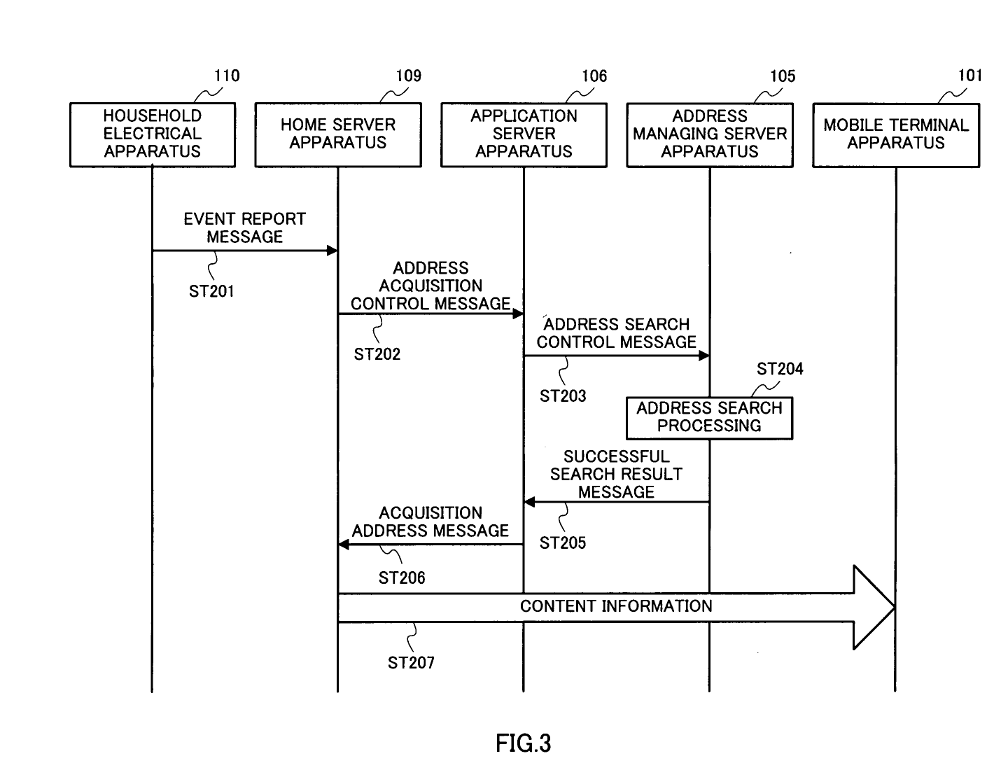

The flow of the operations of reporting system 100 will be described next with reference to FIG. 3.

As shown in FIG. 3, household electrical apparatus (including, for example, refrigerator, video apparatus, DVD apparatus) 110 transmits an event report message (containing event identification information for identifying the event and content information) to home server apparatus 109 when an event necessary to be reported to the user using mobile terminal apparatus 101 occurs (step ST201).

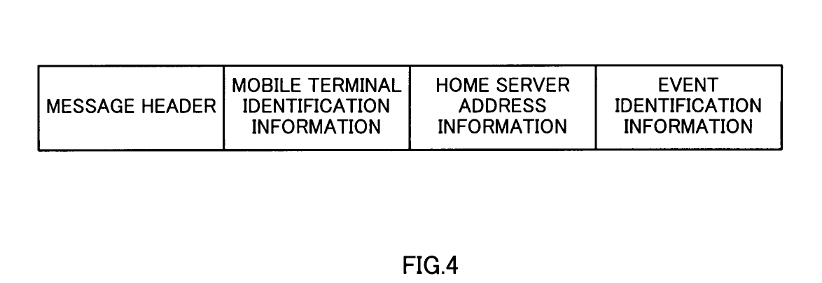

Upon receiving of the event report message, home server apparatus 109 stores this event report message, generates a address acquisition control message, and transmits the address acquisition control message to application server apparatus 106 via router apparatus 107 and network system 103 (step ST202). As shown in FIG. 4, the address acquisition control message is comprised of: a message header (here, indicating the address acquisition control message); the mobile terminal identification information for identifying mobile terminal apparatus 101; home server address information indicating an address of home server apparatus 109; and the event identification information.

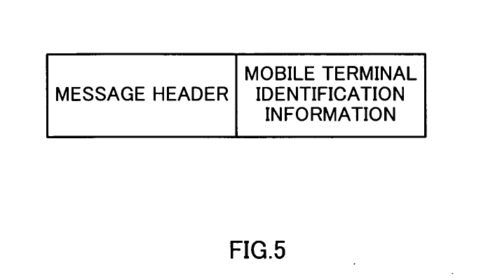

Upon receiving the address acquisition control message, application server apparatus 106 generates an address search control message, and transmits the address search message to address managing server apparatus 105 (step ST203). As shown in FIG. 5, this address search message is comprised of a message header (here, indicating the address search message) and the mobile terminal identification information.

Upon receiving the address search message, address managing server apparatus 105 performs “address search processing” (step ST204). More specifically, address managing server apparatus 105 searches for address information of mobile terminal apparatus 101 stored in association with the mobile terminal identification information using the mobile terminal identification information of the address search message as a key.

When the search is finished, address managing server apparatus 105 generates the search result message and transmits it to application server apparatus 106 (step ST205). The search result message includes a successful search result message indicating that the search succeeds, and a failed search result message indicating that the search results in failure—that is, address information corresponding to the mobile terminal identification information is not found—. FIG. 3 shows a case where address managing server apparatus 105 succeeds in searching.

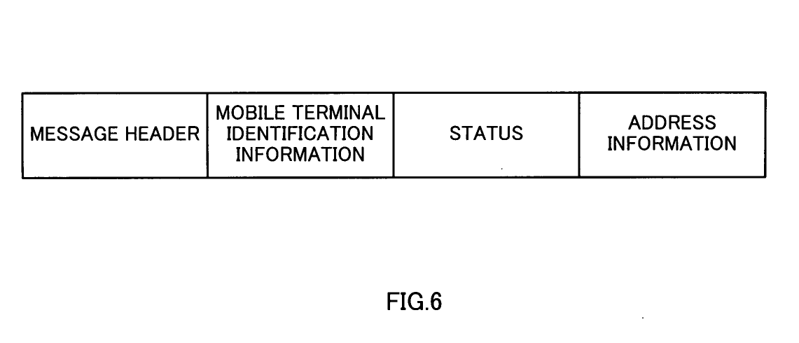

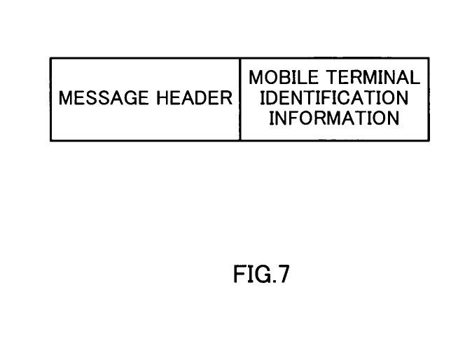

As shown in FIG. 6, this successful search result message is comprised of: a message header (in this case, indicating the successful search result message); the mobile terminal identification information; the status information; and the address information of mobile terminal apparatus 101. In addition, as shown in FIG. 7, the failed search result message is comprised of a message header (in this case, indicating the failed search result message) and the mobile terminal identification information.

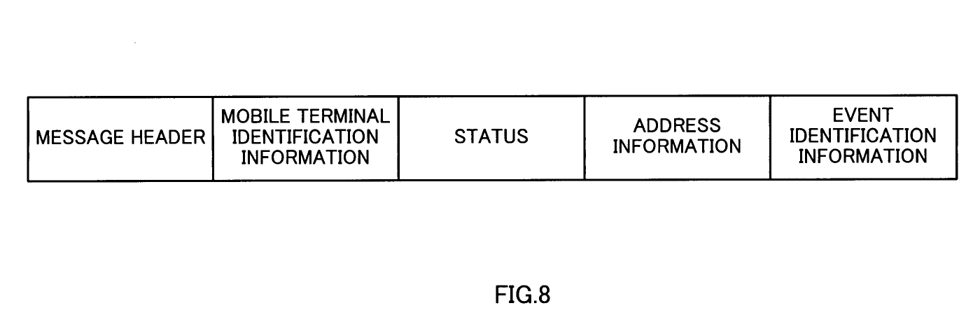

Upon receiving the successful search result message, application server apparatus 106 generates an acquisition address message, and transmits this acquisition address message to home server apparatus 109 (step ST206). As shown in FIG. 8, the acquisition address message is comprised of: a message header (in this case, indicating the acquisition address message); the mobile terminal identification information; the status information; the address information of mobile terminal apparatus 101; and the event identification information.

Upon receiving the acquisition address message, home server apparatus 109 transmits the content information stored in association with the event identification information of this acquisition address message, to mobile terminal apparatus 101 having the address information contained in this acquisition address message (step ST207).

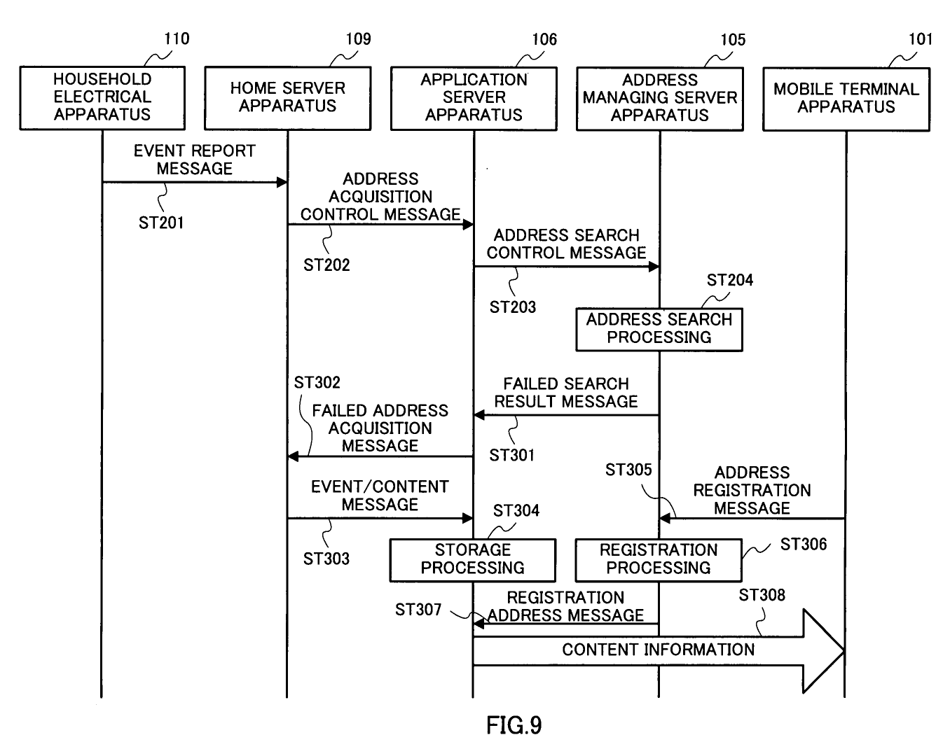

The flow of the operations of reporting system 100 when the search fails in the address search processing in step ST204 in FIG. 3 will be described with reference to FIG. 9.

In FIG. 9, the operations of reporting system 100 from step ST201 to step ST204 are the same as in FIG. 3.

When the search fails in the address search processing in step ST204, address managing server apparatus 105 generates a failed search result message (see FIG. 7), and transmits this failed search result message to application server apparatus 106 (step ST301).

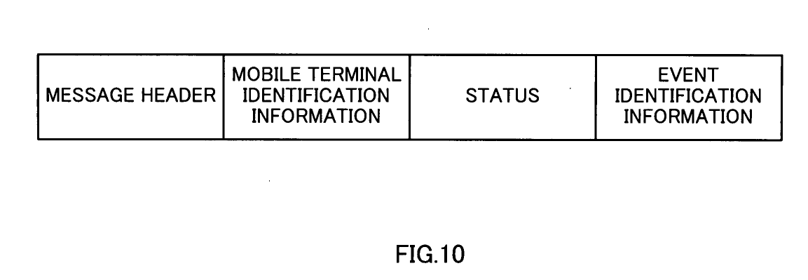

Upon receiving the failed search result message, application server apparatus 106 generates a failure address acquisition message, and transmits this failure address acquisition message to home server apparatus 109 (step ST302). As shown in FIG. 10, this failure address acquisition message is comprised of: a message header (in this case, indicating the failure address acquisition message); the mobile terminal identification information; the status information; and the event identification information.

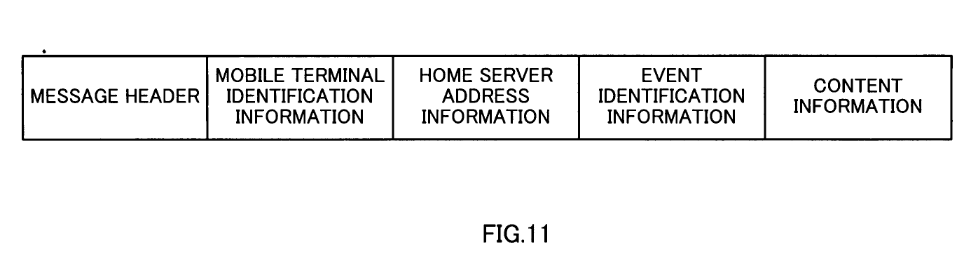

Upon receiving the failed search result message, home server apparatus 109 generates an event/content message including the content information stored in association with the event identification information of this failed search result message, and transmits this event/content message to application server apparatus 106 (step ST303). As shown in FIG. 11, this event/content message is comprised of: a message header (in this case, indicating the event/content message); the mobile terminal identification information; the home server address information; the event identification information; and the content information.

Upon receiving the event/content message, application server apparatus 106 stores the event/content message (step ST304).

In addition, mobile terminal apparatus 101 performs “address registration processing,” for example, when mobile terminal apparatus 101 is powered on, or enters a communication zone with the network system, or when the address information is changed (steps ST305 and ST306).

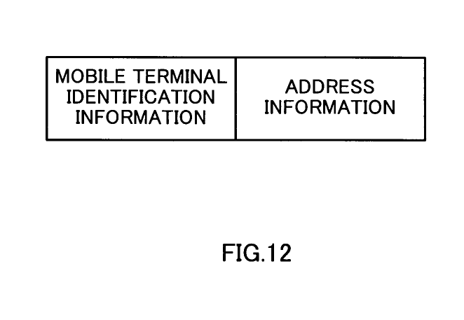

After finishing the “address registration processing,” address managing server apparatus 105 generates a registration address message, and transmits this registration address message to application server apparatus 106 (step ST307). As shown in FIG. 12, this registration address message is comprised of the mobile terminal identification information and the address information.

Upon receiving the registration address message, application server apparatus 106 determines whether or not the event/content message corresponding to the mobile terminal identification information of the registration address message is stored. As a result of this determination, when the event/content message corresponding to the mobile terminal identification information of the registration address message is stored, application server apparatus 106 transmits the content information contained in the event/content message to mobile terminal apparatus 101 having the address information contained in the registration address message (step ST308).

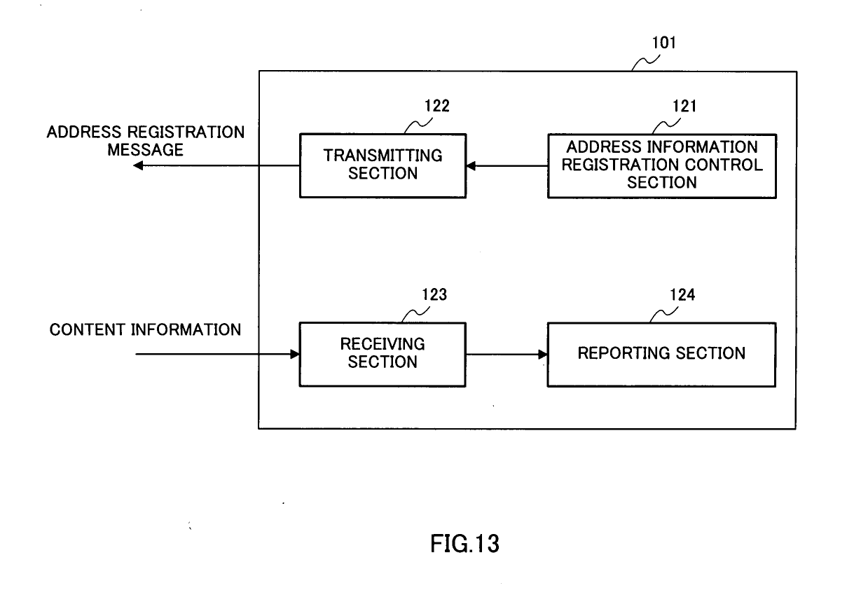

FIG. 13 is a block diagram illustrating a configuration of mobile terminal apparatus 100.

As shown in FIG. 13, mobile terminal apparatus 101 has address information registration control section 121, transmitting section 122, receiving section 123 and reporting section 124.

Address information registration control section 121 generates an address registration message, for example, when mobile terminal apparatus 101 is powered on, or enters a communication zone with the network system, or when the address information is changed, and outputs this address registration message to transmitting section 122. Address registration control section 121 may be configured to generate an address registration message at predetermined intervals and output this address registration message to transmitting section 122.

Transmitting section 122 transmits the address registration message from address information registration control section 121 to address managing server apparatus 105.

Receiving section 123 receives the content information transmitted from application server apparatus 106 or home server apparatus 109, and outputs the result to reporting section 124.

Reporting section 124 reports the content of the content information from receiving section 123.

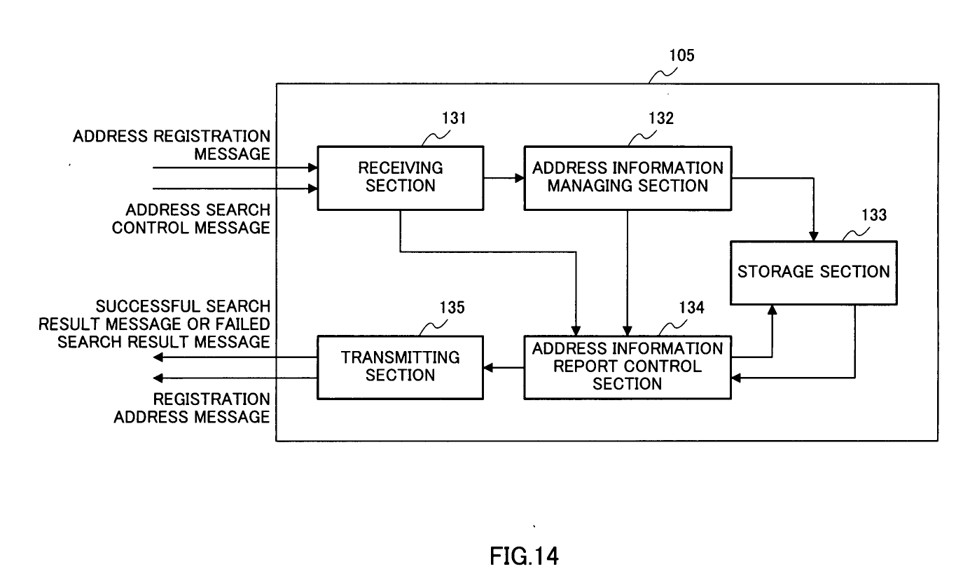

FIG. 14 is a block diagram illustrating a configuration of address managing server apparatus 105.

As shown in FIG. 14, address managing server apparatus 105 has receiving section 131, address information managing section 132, storage section 133, address information report control section 134 and transmitting section 135.

In address managing server apparatus 105, receiving section 131 receives the address registration message from mobile terminal apparatus 101, and outputs the result to address information managing section 132.

Address information managing section 132 receives the address registration message from receiving section 131, and overwrites the data with the mobile terminal identification information and address information of the address registration message when storage section 133 stores the address information identical to the mobile terminal identification information of the address registration message, or stores the mobile terminal identification information and address information of the address registration message when storage section 133 does not store the address information identical to the mobile terminal identification information of the address registration message. Further, address information managing section 132 outputs the mobile terminal identification information and address information of the address registration message to address information report control section 134.

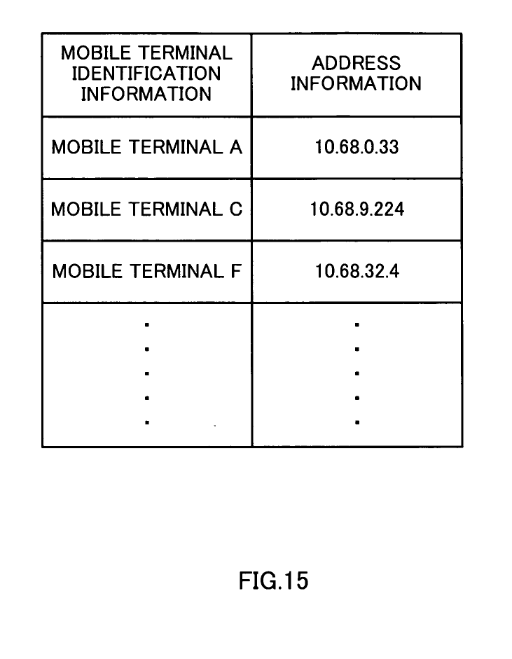

As shown in FIG. 15, storage section 133 associates the mobile terminal identification information with the address information input from address information managing section 132 and stores the result.

Address information report control section 134 outputs the mobile terminal identification information and address information from address information managing section 132 to transmitting section 135 as a registration address message.

Transmitting section 135 transmits the registration address message from address information report control section 134 to application server apparatus 106.

Further, in address managing server apparatus 105, receiving section 131 receives an address search control message from application server apparatus 106 and outputs the message to address information report control 134.

Upon receiving the address search control message from receiving section 131, address information report control section 134 searches whether or not storage section 133 stores the address information corresponding to the mobile terminal identification information of that address search control message.

As a result of this search, when storage section 133 stores the address information corresponding to the mobile terminal identification information of the address search control message received from receiving section 131, address information report control section 134 generates a successful search result message from that address information stored in storage section 133 and the address search control message, and outputs the message to transmitting section 135.

Meanwhile, as a result of the search, when storage section 133 does not store the address information corresponding to the mobile terminal identification information of the address search control message received from receiving section 131, address information report control section 134 generates a failed search result message and outputs the message to transmitting section 135.

Transmitting section 135 transmits the successful search result message or failed search result message from address information report control section 134 to application server apparatus 106.

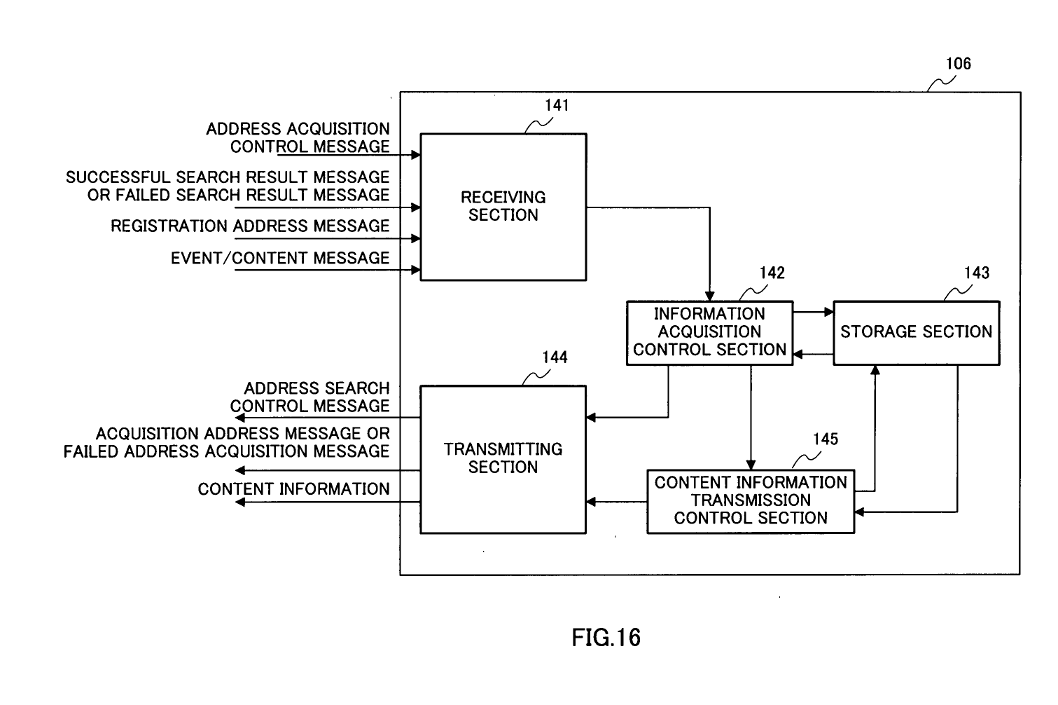

FIG. 16 is a block diagram illustrating a configuration of application server apparatus 106.

As shown in FIG. 16, application server apparatus 106 has receiving section 141, information acquisition control section 142, storage section 143, transmitting section 144, and content information transmission control section 145.

With application server apparatus 106, when receiving section 141 receives an address acquisition control message from home server apparatus 109, receiving section 141 outputs this address acquisition control message to information acquisition control section 142.

Information acquisition control section 142 associates the mobile terminal identification information, home server address information, and event identification information, each contained in the address acquisition control message, with one another and outputs the result to storage section 143. Storage section 143 associates the mobile terminal identification information, home server address information, and event identification information from information acquisition control section 142 with one another and stores the result.

Further, upon receiving the address acquisition control message from home server apparatus 109, information acquisition control section 142 generates an address search control message based on that address acquisition control message, and outputs this address search control message to transmitting section 144.

Transmitting section 144 transmits the address search control message from information acquisition control section 142 to address managing server apparatus 105.

Further, in application server apparatus 106, receiving section 141 receives the successful search result message or failed search result message from address managing server apparatus 105, and outputs the successful search result message or failed search result message to information acquisition control section 142.

Upon receiving the successful search result message, information acquisition control section 142 generates an acquisition address message, and outputs the acquisition address message to transmitting section 144. Meanwhile, upon receiving the failed search result message, information acquisition control section 142 generates a failure address acquisition message, and outputs the failed address acquisition message to transmitting section 144.

Transmitting section 144 transmits the acquisition address message or failed address acquisition message to home server apparatus 109.

Further, in application server apparatus 106, receiving section 141 receives an event/content message from home server apparatus 109, and outputs this event/content message to information acquisition control section 142.

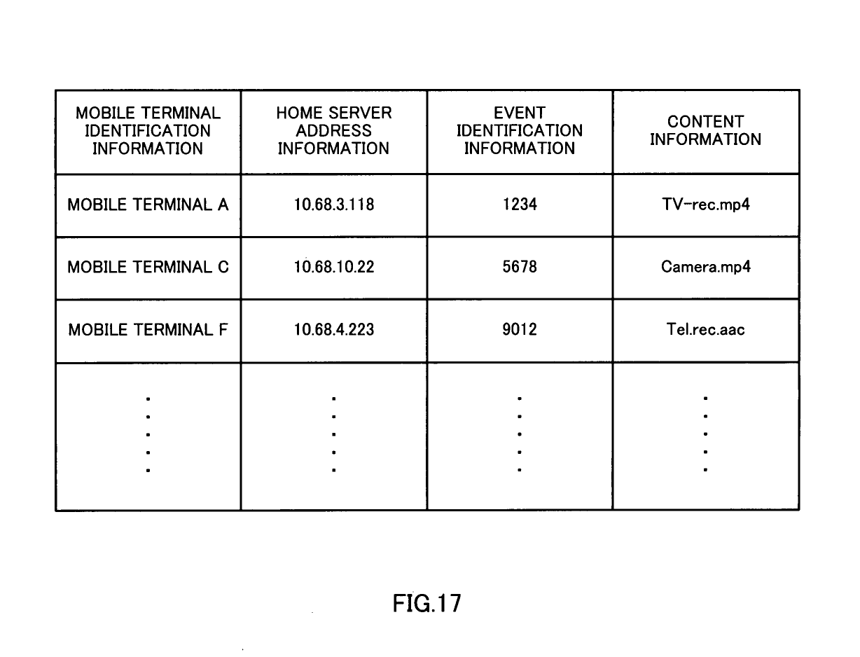

Upon receiving the event/content message from the receiving section, information acquisition control section 142 associates the data stored in storage section 143 that is identical to the mobile terminal identification information, home server address information and event identification information of the event/content message, with the content information contained in the event/content message, and stores the result. Storage section 143 associates the mobile terminal identification information, home server address information and event identification information with the content information corresponding to these, and stores the result. FIG. 17 shows an example of a table storage section 143 holds at this time.

In application server apparatus 106, receiving section 141 receives a registration address message and outputs the message to information acquisition control section 142.

Upon receiving the registration address message from receiving section 141, information acquisition control section 142 searches whether or not storage section 143 stores the content information corresponding to the mobile terminal identification information of this registration address message.

As a result of the search, when storage section 143 stores the content information corresponding to the mobile terminal identification information of the registration address message, the registration address message is outputted to content information transmission control section 145.

Upon receiving the registration address message from information acquisition control section 142, content information transmission control section 145 acquires the content information corresponding to the mobile terminal identification information of the registration address message from storage section 143. Then, content information transmission control section 145 outputs the address information of the registration address message and the content information acquired from storage section 143 to transmitting section 144.

Transmitting section 144 transmits the content information from content information transmission control section 145 to mobile terminal apparatus 101 specified by the address information from content information transmission control section 145.

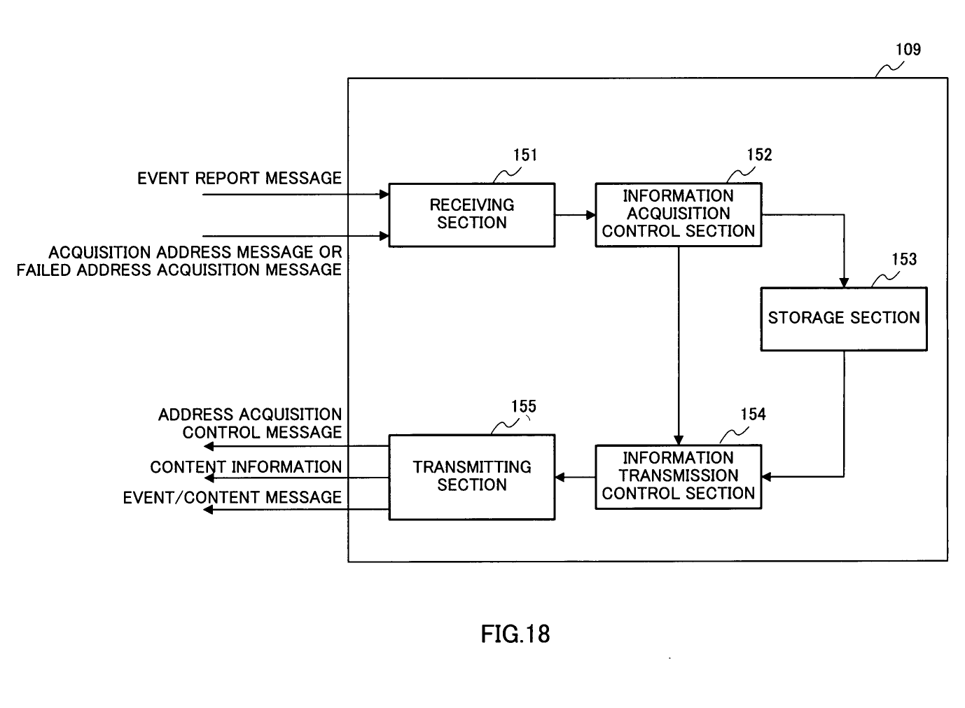

FIG. 18 is a block diagram illustrating a configuration of home server apparatus 109.

As shown in FIG. 18, home server apparatus 109 has receiving section 151, information acquisition control section 152, storage section 153, information transmission control section 154, and transmitting section 155.

In home server apparatus 109, receiving section 151 receives an event report message from household electrical apparatus 110 and outputs the message to information acquisition control section 152.

Upon receiving the event report message from receiving section 151, information acquisition control section 152 outputs the event identification information of this event report message and the content information of the event report message to storage section 153.

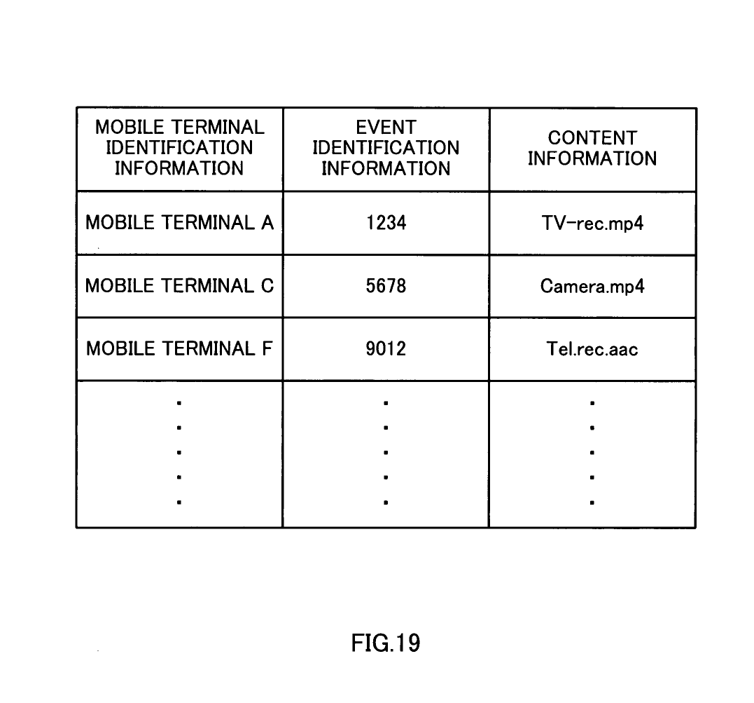

Storage section 153 associates the event identification information with the mobile terminal identification information of mobile terminal apparatus 101 to which the content information corresponding to this event identification information is to be transmitted in advance, and stores the result. Then, storage section 153 associates the stored data corresponding to the event identification information from information acquisition control section 152 with the content information from information acquisition control section 152, and stores the result. FIG. 19 shows an example of a table storage section 153 holds at this time.

Further, upon receiving the event report message from receiving section 151, information acquisition control section 152 generates an address acquisition control message, and outputs this address acquisition control message to transmitting section 155 via information transmission control section 154.

Transmitting section 155 receives the address acquisition control message from information acquisition control section 152 and transmits the message to application server apparatus 106.

Further, in home server apparatus 109, receiving section 151 receives the acquisition address message or failed address acquisition message from application server apparatus 106 and outputs the message to information acquisition control section 152.

Upon receiving the acquisition address message or failed address acquisition message, information acquisition control section 152 outputs the message to information transmission control section 154.

Upon receiving the acquisition address message from information acquisition control section 152, information transmission control section 154 acquires the content information stored in storage section 153 corresponding to the mobile terminal identification information and event identification information of the acquisition address message. Then, information transmission control section 154 outputs the content information acquired from storage section 153 and the address information contained in the acquisition address message from information acquisition control section 152 to transmitting section 155.

Transmitting section 155 transmits the content information from information transmission control section 154 to mobile terminal apparatus 101 specified by the address information from information transmission control section 154.

Meanwhile, upon receiving the failed address acquisition message from information acquisition control section 152, information transmission control section 154 generates an event/content message, and outputs this event/content message to transmitting section 155. The event/content message is generated based on the failed address acquisition message from information acquisition control section 152, the content information stored in storage section 153 corresponding to the mobile terminal identification information and the event identification information of this failed address acquisition message, and the home server address information of home server apparatus 109.

Transmitting section 155 transmits the event/content message from information transmission control section 154 to application server apparatus 106.

With the above-mentioned explanation, that the description has been made assuming that home server apparatus 109 generates an event/content message upon receiving a failed search result message, and transmits this event/content message to application server apparatus 106 (step ST303). However, a configuration may also be adopted where home server apparatus 109 has a timer section (not shown) that measures an elapsed time after home server apparatus 109 transmits the address acquisition control message, and, when this elapsed time exceeds a predetermined time, information acquisition control section 152 in home server apparatus 109 generates a failed search result message from the information stored in storage section 153 corresponding to the address acquisition control message, and outputs the message to information transmission control section 154.

Further, in the above-mentioned explanation, upon receiving the failed search result message, application server apparatus 106 generates a failed address acquisition message, and transmits this failed address acquisition message to home server apparatus 109 (step ST302). Then, the description has been made assuming that, upon receiving the failed search result message, home server apparatus 109 generates an event/content message including the content information stored corresponding to the event identification information of this failed search result message, and transmits this event/content message to application server apparatus 106 (step ST303). However, in step ST202, the corresponding content information can be contained in the address acquisition control message application server apparatus 109 generates and transmits. By this means, the operations in steps ST302 and ST303 are unnecessary.

Thus, according to this embodiment, address managing server 105 acquires the latest address information of mobile terminal apparatus 101. In home server apparatus 109, storage section 153 stores (holds) the content information from household electrical apparatus 110, and information acquisition control section 152 controls to acquire the address information of the mobile terminal apparatus from address managing server apparatus 105. Then, home server apparatus 109 transmits the above content information stored in storage section 153 to mobile terminal apparatus 101 specified by the address information acquired from address managing server apparatus 105. In mobile terminal apparatus 101, the content information transmitted from home server apparatus 109 is received, and reporting section 124 reports the content of the content information.

In this way, home server apparatus 109 stores the content information from household electrical apparatus 110, acquires the latest address information of mobile terminal apparatus 101 from address managing server apparatus 105, and transmits the above content information to this latest address, so that it is possible to improve reliability of reporting to the user in mobile terminal apparatus 101.

Further, according to this embodiment, in home server apparatus 109, when information acquisition control section 152 cannot acquire the address information of the mobile terminal apparatus from address managing server apparatus 105, the content information from household electrical apparatus 110 stored in storage section 153 is transmitted to application server apparatus 106. In application server apparatus 106, storage section 143 stores the above content information form home server apparatus 109, and information acquisition control section 142 controls to acquire the latest address information of mobile terminal apparatus 101 from address managing server apparatus 105. Then, application server apparatus 106 transmits the content information stored in storage section 143 to mobile terminal apparatus 101 specified by the address information acquired from address managing server apparatus 105.

Application server apparatus 106 stores the content information from household electrical apparatus 110, acquires the latest address information of mobile terminal apparatus 101 from address managing server apparatus 105, and transmits the content information to this latest address, so that it is possible to improve reliability of reporting to the user in mobile terminal apparatus 101.

With the above-mentioned explanation, mobile terminal apparatus 101 performs “address registration processing” when, for example, mobile terminal apparatus 101 is powered on, or enters a communication zone with the network system, or when the address information is changed (steps ST305 and ST306). Then, the description has been made assuming that after finishing the “address registration processing,” address managing server apparatus 105 generates a registration address message, and transmits this registration address message to application server apparatus 106 (step ST307), and application server apparatus 106 acquires the address information of mobile terminal apparatus 101. However, application server apparatus 106 may inquire of address managing server apparatus 105 at regular time intervals and acquire the address information of mobile terminal. apparatus 101.

More specifically, upon receiving an address acquisition control message from home server apparatus 109, information acquisition control section 142 in application server apparatus 106 generates an address search control message based on that address acquisition control message, and outputs this address search control message to transmitting section 144. Then, transmitting section 144 transmits the address search control message from information acquisition control section 142 to address managing server apparatus 105. The above-mentioned operations of information acquisition control section 142 and transmitting section 144 are repeated on a regular basis until the address information of mobile terminal apparatus 101 is acquired.

Then, address information managing section 132 in address managing server apparatus 105 receives the address registration message from receiving section 131, and when storage section 133 stores the address information identical to the mobile terminal identification information of the address registration message, overwrites the data with the mobile terminal identification information and address information of the address registration message, while storing the mobile terminal identification information and address information of the address registration message when storage section 133 does not store the address information identical to the mobile terminal identification information of the address registration message.

Then, at the time of receiving an address acquisition control message from application server apparatus 106, when storage section 133 stores the mobile terminal identification information and address information corresponding to the address acquisition control message, address information report control section 134 outputs the mobile terminal identification information and address information to transmitting section 135 as a registration address message.

In the above-mentioned explanation, it is described that when receiving the failed search result message, application server apparatus 106 generates a failed address acquisition message, and transmits the failed address acquisition message to home server apparatus 109 (step ST302). Then, it is further described that when receiving the failed search result message, home server apparatus 109 generates content information corresponding to the event identification information of the failed search result message, and that home server apparatus 109 generates an event/content message including the content information, and transmits the event/content message to application server apparatus 106 (step ST303).

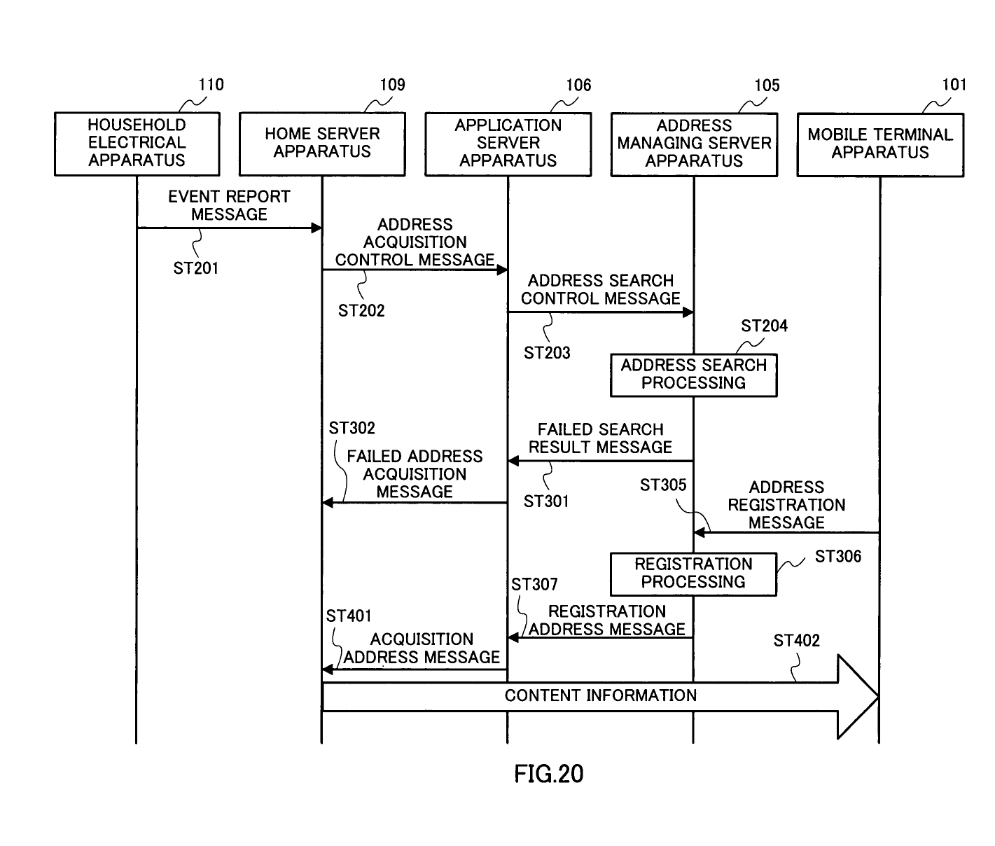

However, as shown in FIG. 20, home server apparatus 109 may not transmit an event/content message to application server apparatus 106 even when home server apparatus 109 receives a failed address acquisition message from application server apparatus 106.

In this case, upon receiving the registration address message from address managing server apparatus 105 in step ST307, application server apparatus 106 generates an acquisition address message and transmits this acquisition address message to home server apparatus 109 (step ST401).

Then, upon receiving the acquisition address message from application server apparatus 106, home server apparatus 109 transmits the content information stored corresponding to the event identification information of the acquisition address message, to mobile terminal apparatus 101 specified by the address information of the acquisition address message (step ST402).

More specifically, in application server apparatus 106, upon receiving the registration address message from receiving section 141, information acquisition control section 142 generates an acquisition address message from this registration address message, and the mobile terminal identification information and event identification information stored in storage section 143. Then, information acquisition control section 142 transmits this acquisition address message to home server apparatus 109 specified by the home server address information corresponding to the mobile terminal identification information contained in the registration address message (step ST401).

Then, in home server apparatus 109, upon receiving the acquisition address message or failed address acquisition message from receiving section 151, information acquisition control section 152 outputs the message to information transmission control section 154. Upon receiving the acquisition address message from information acquisition control section 152, information transmission control section 154 acquires the content information stored in storage section 153 corresponding to the mobile terminal identification information and event identification information of this acquisition address message. Then, information transmission control section 154 outputs the content information acquired from storage section 153 and the address information contained in the acquisition address message from information acquisition control section 152 to transmitting section 155. Transmitting section 155 transmits the content information from information transmission control section 154 to mobile terminal apparatus 101 specified by the address information from information transmission control section 154 (step ST402).

In this way, home server apparatus 109 stores the content information from household electrical apparatus 110, acquires the latest address information of mobile terminal apparatus 101 from address managing server apparatus 105, and transmits the above content information to this latest address, so that it is possible to improve reliability of reporting to the user in mobile terminal apparatus 101.

When the content information in the above-mentioned explanation is information such as a TV program requiring some time, reporting system 100 operates as described below.

As shown in FIG. 3, in a case where home server apparatus 109 receives an acquisition address message from application server apparatus 106, home server apparatus 109 transmits the content information transmitted from household electrical apparatus 110 successively to mobile terminal apparatus 101 in step ST207, upon acquiring the address information of mobile terminal apparatus 101.

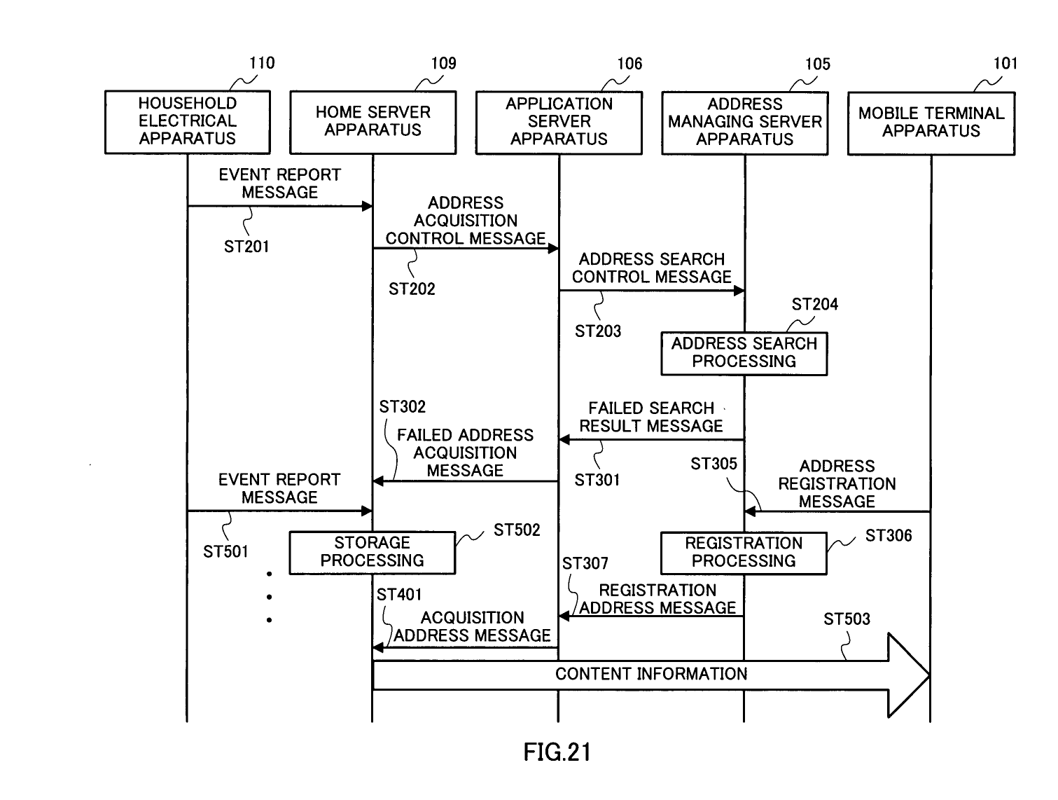

Meanwhile, when home server apparatus 109 receives a failed address acquisition message from application server apparatus 106, as shown in FIG. 21, in step ST501, home server apparatus 109 receives an event report message transmitted from household electrical apparatus 110 the same as in step ST201 (however, based on an assumption that the content information here is, for example, a TV program, the content information contains, for example, divided consecutive image information, and, therefore, even in a case of the same kind of event report massage, the content information contained in the event report message is different) during a period before acquiring the address information of mobile terminal apparatus 101 as a destination in step ST401.

Then, home server apparatus 109 repeats storing processing of the content information of the event report message from household electrical apparatus 110 (step ST502).

Then, upon acquiring the address information of mobile terminal apparatus 101 in step ST401, home server apparatus 109 transmits the content information subjected to storage processing in step ST502 thus far and the content information transmitted from household electrical apparatus 101, to mobile terminal apparatus 101 (step ST503) successively.

For example, this case corresponds to service that a user registers an interesting TV program with home server apparatus 109 in advance, and that home server apparatus 109 reports the user at a predetermined time. In a form of this service, home server apparatus 109 reports to the user, and, at the same time, transfers the TV program via the network, and the user sees the TV program using mobile terminal apparatus 101. When home server apparatus 109 cannot report to the user when trying to report, home server apparatus 109 starts recording the TV program, and transmits the recorded program when the user is able to communicate.

In the above-mentioned explanation, the description has been made assuming that, in steps ST207, ST308 and ST402, when home server apparatus 109 or application server apparatus 106 is able to acquire the latest address information of mobile terminal apparatus 101, the content information is transmitted to mobile terminal apparatus 101. However, a configuration may also adopted where, when home server apparatus 109 or application server apparatus 106 is able to acquire the latest address information of mobile terminal apparatus 101, the event identification information is first transmitted to mobile terminal apparatus 101, and home server apparatus 109 or application server apparatus 106 transmits the content information corresponding to the event identification information to mobile terminal apparatus 101, after receiving instructions of the user reported the event specified by the event identification information.

Further, although the description has been made with the above-mentioned explanation that address managing server apparatus 105 and application server apparatus 106 are different apparatuses, address managing server apparatus 105 and application server apparatus 106 may also be configured in an integrated form. Also, although the description has been made that home server apparatus 109 and household electrical apparatus 110 are different apparatuses, home server apparatus 109 and household electrical apparatus 110 may also be configured in an integrated form.

Furthermore, although the description has been made using home server apparatus 109 and household electrical apparatus 110 on home-use network system 108 with the above-mentioned explanation, the present invention is not limited to home-use network and apparatuses, and is also applicable to a network system such as an intracompany network system, and the server apparatus and electrical apparatus in that system.

For example, assume that home server apparatus 109 is replaced with call control server apparatus 605 on the intracompany network, household electrical apparatus 110 is replaced with intracompany terminal apparatus 604 on the intracompany network, and that intracompany terminal apparatus 604 places a call to mobile terminal apparatus 101.

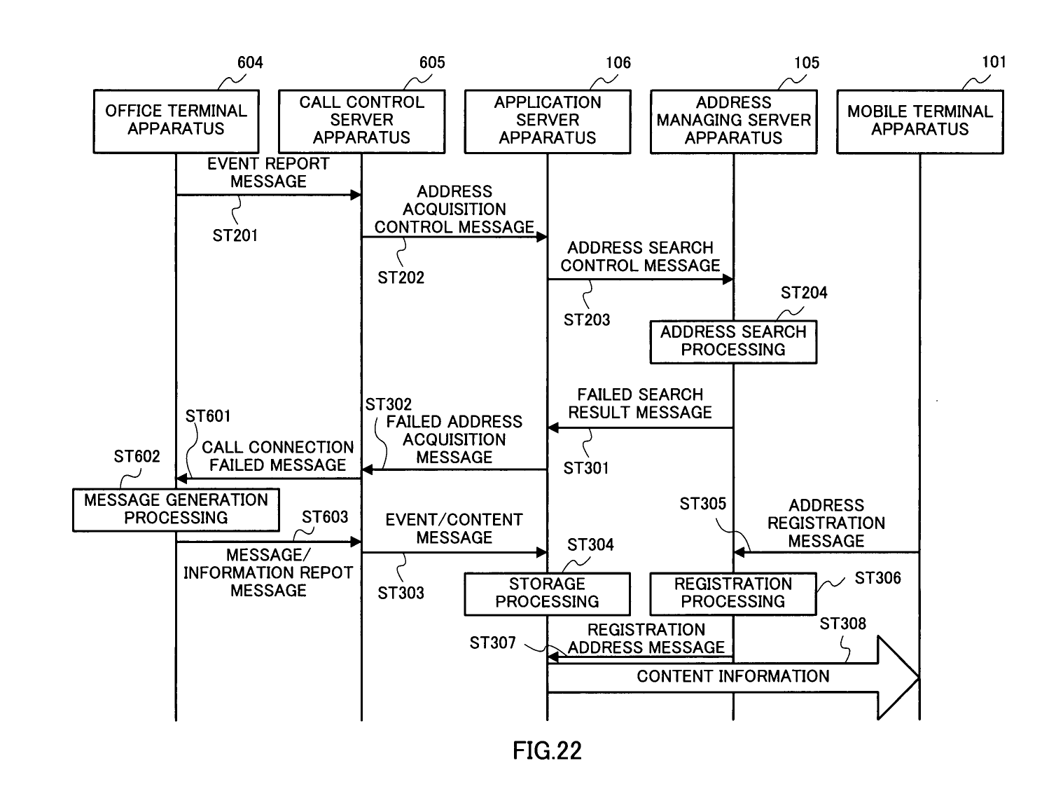

Here, if, for example, mobile terminal apparatus 101 is out of the communication zone, and does not succeed in receiving the call, call control server apparatus 605 is reported address acquisition failure (see FIG. 22) by the same operation sequence as described in the above-mentioned embodiment. In other words, in FIG. 22, the operations in steps ST201 to ST302 are the same as in FIG. 9.

Next, when call control server apparatus 605 reports that the call fails (step ST601) to intracompany terminal apparatus 604, intracompany terminal apparatus 604 generates message information for mobile terminal apparatus 101 (step ST602) and transmits the message information as a message-information report message (step ST603) to call control server apparatus 605. Call control server apparatus 605 transmits the message information to application server apparatus 106 (step ST303), and application server apparatus 106 holds this message information (step ST304).

After that, by the same operation sequence as in the above-mentioned embodiment, when mobile terminal apparatus 101 enters the communication zone, the message information is distributed to mobile terminal apparatus 101. In other words, in FIG. 22, the operations of reporting system 100 in steps ST305 to ST308 are the same as in FIG. 9.

As described above, according to this embodiment, the server apparatus stores the content information from an electrical apparatus, acquires the latest address information of the mobile terminal apparatus, and transmits the content information to the latest address information, so that it is possible to improve reliability of reporting to the user in the mobile terminal apparatus.

The present application is based on Japanese Patent Applications No. 2004-191765 filed on Jun. 29, 2004, and No. 2005-167695 filed on Jun. 8, 2005, the entire contents of which are expressly incorporated by reference herein.

### INDUSTRIAL APPLICABILITY

According to the present invention, the server apparatus stores the content information from an electrical apparatus, acquires the latest address information of the mobile terminal apparatus, and transmits the content information to the latest address information, so that it is useful as a reporting system, mobile terminal apparatus and server apparatus for improving reliability of reporting to the user in the mobile terminal apparatus.

1-10. (canceled)

11. A reporting system comprising a mobile terminal apparatus, a first server apparatus that carries out transmission control of transfer information to be informed to the mobile terminal apparatus, and a second server apparatus that manages address information of the mobile terminal apparatus, wherein:
the first server apparatus has:
a holding section that holds the transfer information;
an address information acquiring section that acquires the address information from the second server apparatus; and
a transmission controlling section that controls transmission of the transfer information to the second server apparatus when the address information acquiring section is not able to acquire the address information;
the second server apparatus has:
a holding section that holds the transfer information from the first server apparatus;
an address information acquiring section that acquires the address information from the mobile terminal apparatus; and
a transmitting section that transmits the transfer information held in the holding section to the mobile terminal apparatus specified by the address information; and
the mobile terminal apparatus has:
a receiving section that receives the transfer information; and
a reporting section that reports the received transfer information.

12. The reporting system according to claim 11, wherein the second server apparatus comprises:
an address information managing server comprising the address information acquiring section; and
a server apparatus comprising the holding section, the transmission section, and another address information acquiring section that acquires the address information acquired by the address information managing server apparatus, wherein the address information acquiring section of the address information managing server apparatus acquires terminal identification information together with the address information from the mobile terminal apparatus.

13. A server apparatus comprising:
a holding section that holds transfer information to be informed to a mobile terminal apparatus; and
a transmission control section that, when a response to a request signal of address information to a managing apparatus that manages address information of the mobile terminal apparatus indicates that the address information is not acquired, controls a proxy apparatus that transmits the transfer information to the mobile terminal apparatus for the server apparatus to acquire the transfer information and the address information.

14. A mobile terminal apparatus that communicates with a server apparatus that manages address information, comprising:
an address information acquiring section that acquires address information assigned to the mobile terminal apparatus; and
a transmission section that transmits the address information to the server apparatus when the mobile terminal apparatus is powered on, when the mobile terminal apparatus enters a communication area with a network system, or when the address information is changed;
a receiving section that receives transfer information for the address information; and
a reporting section that reports the received transfer information.

15. The mobile terminal apparatus according to claim 14, wherein the transmission section transmits terminal identification information of the mobile terminal apparatus together with the address information to the server apparatus when the mobile terminal apparatus is powered on, when the mobile terminal apparatus enters a communication area with a network system, or when the address information is changed.
